(19) United States
(12) Patent Application Publication
(10) Pub. No.: US 2017/0344930 A1
(43) Pub. Date: Nov. 30, 2017

(54) INTEGRATED CRM AND PROJECT MANAGEMENT

(71) Applicant: Peter Lasensky, San Diego, CA (US)

(72) Inventor: Peter Lasensky, San Diego, CA (US)

(21) Appl. No.: 15/604,639

(22) Filed: May 24, 2017

Related U.S. Application Data
(60) Provisional application No. 62/340,994, filed on May 24, 2016.

(51) Int. Cl. G06Q 10/06; G06Q 30/00

(52) U.S. Cl. CPC G06Q 10/063114; G06Q 30/01; G06Q 10/06; G06Q 10/063118; G06Q 10/06313

(57) ABSTRACT

A system for provisioning a user in a project management system includes receiving, at a customer relationship management platform, a request from an authorizing user to add a user to a project, sending an invitation to the user to join the project, via a networking platform, receiving an acceptance from the user and storing user contact information from the networking platform, and authorizing access by the user to one or more project applications, wherein the user is provisioned in a project management system.

### RELATED APPLICATIONS

This application claims priority to U.S. Provisional Application No. 62/340,994, filed on May 24, 2016.

### BACKGROUND

Typical CRM (Customer Relationship Management) systems are used to manage leads and opportunities only up until contracts are awarded, when the relevant data must be ported to project management platforms and applications, which have incompatible data formats, software development kits (SDKs) and application program interfaces (APIs).

### BRIEF DESCRIPTION OF THE DRAWINGS

For a more complete understanding of various examples, reference is now made to the following description taken in connection with the accompanying drawings in which:

FIG. 1 is a block diagram illustrating an example system with a computer-readable storage medium including instructions executable by a processor for integrated CRM and project management;

FIG. 2 is a block diagram illustrating an example system comprising multiple instances of the example system of FIG. 1;

FIG. 3 is a flowchart illustrating an example process for integrated CRM and project management;

FIG. 4 is a communication flow diagram illustrating an example process for associating a user with a project in an integrated CRM and project management system; and

FIG. 5 is a communications flow diagram illustrating an example process for data sharing in an integrated CRM and project management system.

### DETAILED DESCRIPTION

The present disclosure describes examples of integrated CRM (customer relationship management) and project management systems. Various examples include a system comprising a processor coupled to a non-transitory computer-readable medium, wherein the non-transitory computer-readable medium is configured to store instructions executable by the processor to receive a request from an authorizing user to add a user to a project; send an invitation to the user to join the project, via a networking platform; receive an acceptance from the user and storing user contact information from the networking platform; and authorize access by the user to one or more project applications, wherein the user is provisioned in a project management system. In one example, in order to authorize access by the user, the non-transitory computer-readable medium includes instructions to associate the user with a project; update a project list and a project user list; send the project list and the project user list to the one or more project applications; and receive confirmation of the association from the one or more project applications.

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

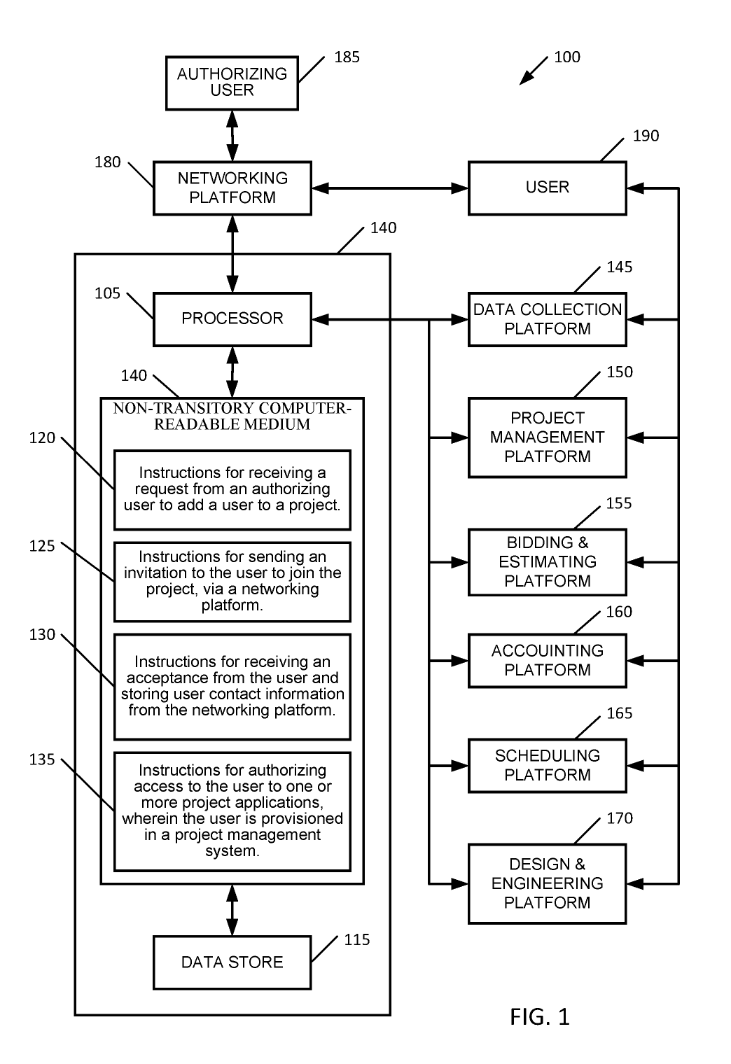

Referring now to FIG. 1, there is illustrated a block diagram of an example system with a non-transitory computer-readable storage medium including instructions executable by a processor for integrated CRM and project management. The example system 100 includes a processor 105 coupled with a non-volatile computer-readable storage medium 110 and a data store 115. The non-transitory computer-readable storage medium 110 includes example instructions 120, 125, 130 and 135 that are executable by the processor 105 to perform various functionalities described herein. The data store 115 may contain data files needed to execute instructions 120-135.

In various examples, the non-transitory computer-readable storage medium 110 and the data store 115 may be any of a variety of storage devices including, but not limited to, random-access memory (RAM), dynamic RAM (DRAM), static RAM (SRAM), flash memory, read-only memory (ROM), programmable ROM (PROM), electrically erasable PROM (EEPROM), or the like. In various examples, the processor 105 may be a general-purpose processor, special purpose logic, or the like.

System 100 may also include examples of various application platforms related to project management, data collection, and contract and contact management. As used herein, the term “platform” means a vehicle for providing one or more functions or applications. A platform may include hardware, firmware, software of any combination thereof. Platforms may be stand-alone vehicles for providing a single function or may combine one or more functions or applications.

Returning now to FIG. 1, system 100 may include an enhanced CRM platform 140 comprising processor 105, computer-readable medium 110 and data store 115 as previously described to provide an enhanced CRM application. In one example, enhanced CRM platform 140 may provide the Command Post CRM application, available from NoteVault, Inc. of San Diego, Calif.

System 100 may also include a data collection and communication platform 145 to provide a data collection application for managing and coordinating project resources such as companies, personnel and material. In one example, Platform 100 may be provided by the NoteVault application, available from NoteVault, Inc. of San Diego, Calif. System 100 may also include a project management platform 150 to provide a project management application. In various examples, the application provided by project management platform 150 may be a commercial project management software application, such as Sage, Primavera, Procore, Aconex, Viewpoint or the like.

System 100 may also include other project support platforms such as bidding & estimating platform 155, accounting platform 160, and scheduling platform 165. In some examples, bidding and estimating platform 155 may be provided by a commercial bidding and estimating software application such as Sage, Buildertrend, CoContruct, IntelliBid or the like. In some examples, accounting platform 160 may be provided by a commercial accounting software application such as Sage, Vista, Procontractor, Foundation or the like. In some examples, scheduling platform 165 may be provided by a commercial scheduling software application such as Buildertrend, Procore, CoConstruct, Sage, Foundation or the like. As indicated by the interconnections 175 between platforms 140, 145, 150, 155, 160, 165 and 170, the platforms may be part of an interconnected network. In various examples, the network may be any type of wired or wireless network, including any type of LAN, WAN, MAN, Cellular, Satellite, etc.

System 100 may also include a networking platform 180 with a network connection 185 to the enhanced CRN platform 140. In some examples. Networking platform may be provided by a commercial networking application such as LinkedIn, for example. As illustrated in FIG. 1 and described in greater detail below, the various platforms may be accessible, either directly or indirectly, to different classes of users, including an authorizing user 185 and a user 190.

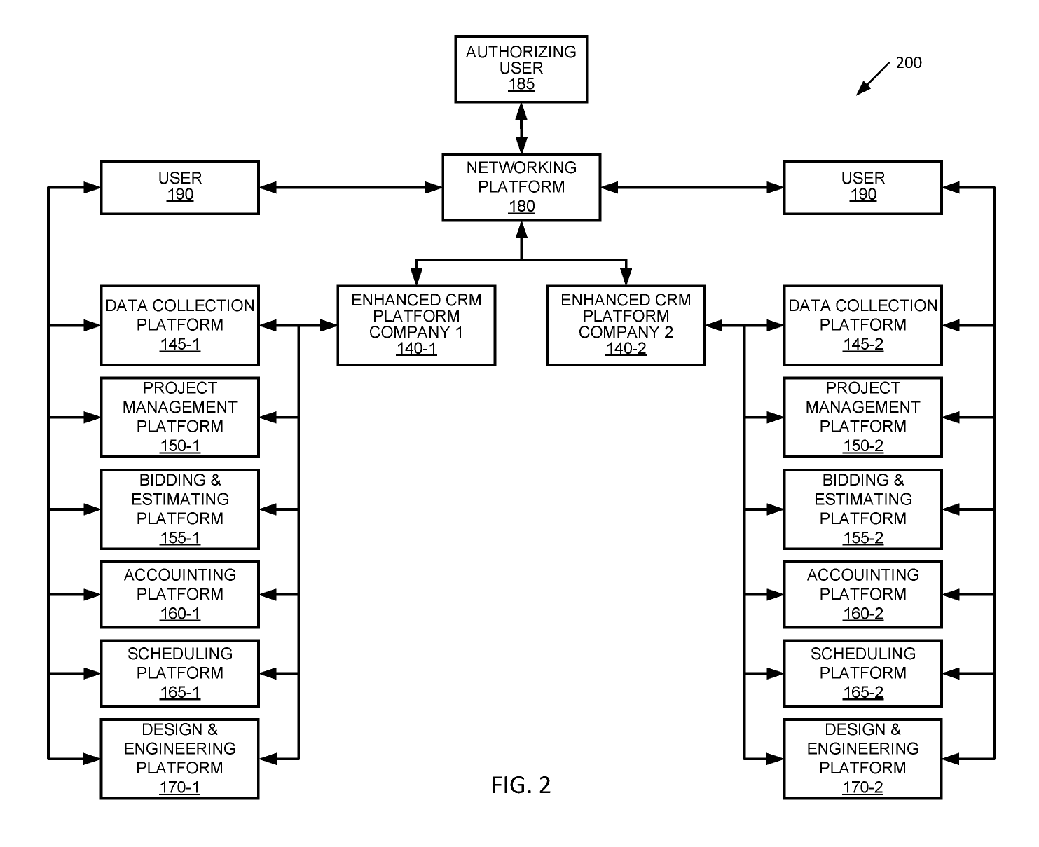

In some examples, the system 100 illustrated in FIG. 1 may be associated with a single business entity, such as a company. In other examples, as illustrated in FIG. 2, the system architecture may be replicated across multiple companies. In FIG. 2, there is illustrated an example system 200 integrating the project management systems of two companies, Company 1 and Company 2. Company 1 maintains its own instances of an enhanced CRM platform (140-1), a data collection platform (145-1), a project management platform (150-1), a bidding and estimating platform (155-1), an accounting platform (160-1), a scheduling platform (165-1), and a design and engineering platform (170-1). Similarly, Company 2 maintains its own instances of an enhanced CRM platform (140-2), a data collection platform (145-2), a project management platform (150-2), a bidding and estimating platform (155-2), an accounting platform (160-2), a scheduling platform (165-2), and a design and engineering platform (170-2).

The networking platform 180 operates in the role of liaison between Company 1 and Company 2, and as a communication link among the authorizing user 185 and users 190-1 and 190-2 (which may be the same or different users). The enhanced CRM platform (140-1) of Company 1 provides liaison between the networking platform 180 and the project related applications of Company 1 (i.e., 145-1, 150-1, 155-1, 160-1, 165-1 and 170-1). Similarly, the enhanced CRM platform (140-2) of Company 2 provides liaison between the networking platform 180 and the project related applications of Company 2 (i.e., 145-2, 150-2, 155-2, 160-2, 165-2 and 170-2).

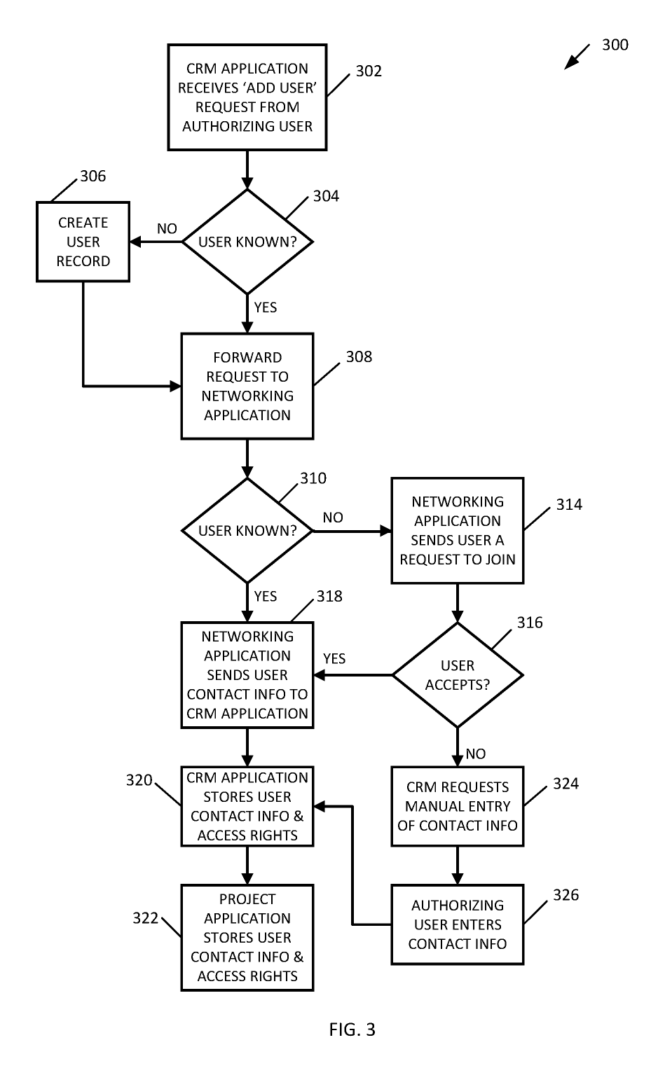

FIG. 3 is a flowchart illustrating an example process 300 for integrated CRM and project management that may be implemented by example system 100 or example system 200. In the following discussion of process 300, reference is made to system 100 for clarity. Additionally, the terms ‘application’ and ‘platform’ are used interchangeable for convenience. Process 300 begins at operation 302, where enhanced CRM application 140 executes instruction 120 to receive a request from an authorizing user 185 to add a user 190 to one or more project applications. In operation, 304, enhanced CRM application 140 determines if the user 190 is known to the enhanced CRM application 140. If the user 190 is not known, then process 300 continues at operation 306 where a record for the user 190 is created (e.g., using any contact information provided by the authorizing user, such as name, email address, and/or mobile telephone number), and the process 300 then continues at operation 308.

If the user 190 is known to the enhanced CRM application 140, then the process 300 proceeds to operation 308 where the enhanced CRM application 140 forwards the add user request to the networking application 180. At operation 310, the networking application determines if the user 190 is known to the networking application. If the user 190 is not known to the networking application 180, then process 300 continues at operation 314 where the networking application 180 executes instruction 125 to send an invitation (e.g., via email, text message, etc.) to the user 190 to join the one or more project applications.

If the user 190 accepts the invitation (e.g., via return email or text message), then process 300 continues at operation 318 where the networking application 180 sends the user's acceptance and contact information to the enhanced CRM application 140. At operation 320, the enhanced CRM application 140 executes instruction 130 to receive and store the user's contact information and access rights to the one or more project applications and instruction 135 to send access authorizations to the one or more project applications. At operation 322, each of the one or more project applications stores the user's contact information and access rights, whereby the user 190 is provisioned in the project management system.

Returning to operation 316, if the user 190 does not accept the invitation to join the one or more project applications, then at operation 324 the enhanced CRM application 140 requests manual entry of the user's contact information and project access rights by the authorizing user 185. At operation 326, the authorizing user 185 enters the required information and the process 300 continues at operation 320 as previously described.

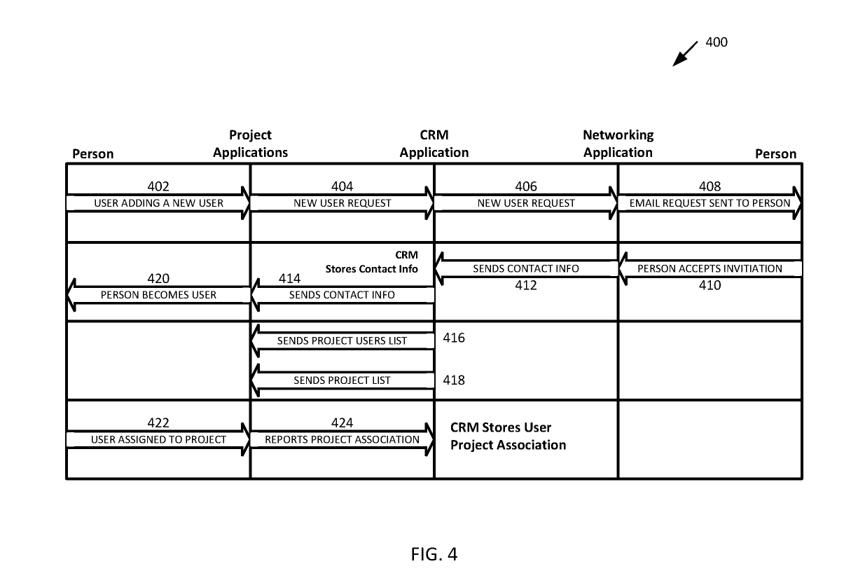

FIG. 4 is a communication flow diagram illustrating an example process 400 for associating a user with a project in an integrated CRM and project management system such as system 100 or system 200. Process 400 begins at step 402, where an existing user of a project application sends a request to the project application to add a new user. Next, in step 404, the project application sends the new user request to the enhanced CRM application 140. Next, in step 406, the enhanced CRM application 140 sends the new user request to the networking application 180. Then, in step 408, the networking application 180 sends an email request to the person identified as the new user. Next, in step 410, the designated new user accepts the invitation by return email to the networking application 180. In step 412, the networking application sends the new user's contact information to the enhanced CRM application 140. In step 414, after storing the new user's contact information, the enhanced CRM application 140 sends the new user's contact information to the requesting project application. In step 416, the enhanced CRM application 140 sends an updated project users list to the project applications. In step 418, the enhanced CRM application 140 sends an updated project list to the project applications. In step 420, the designated new user is notified of their status as a user. In step 422, the user authenticates their assignment to the project application, and in step 424, the project application reports the user's association with the project application to the enhanced CRM application 140.

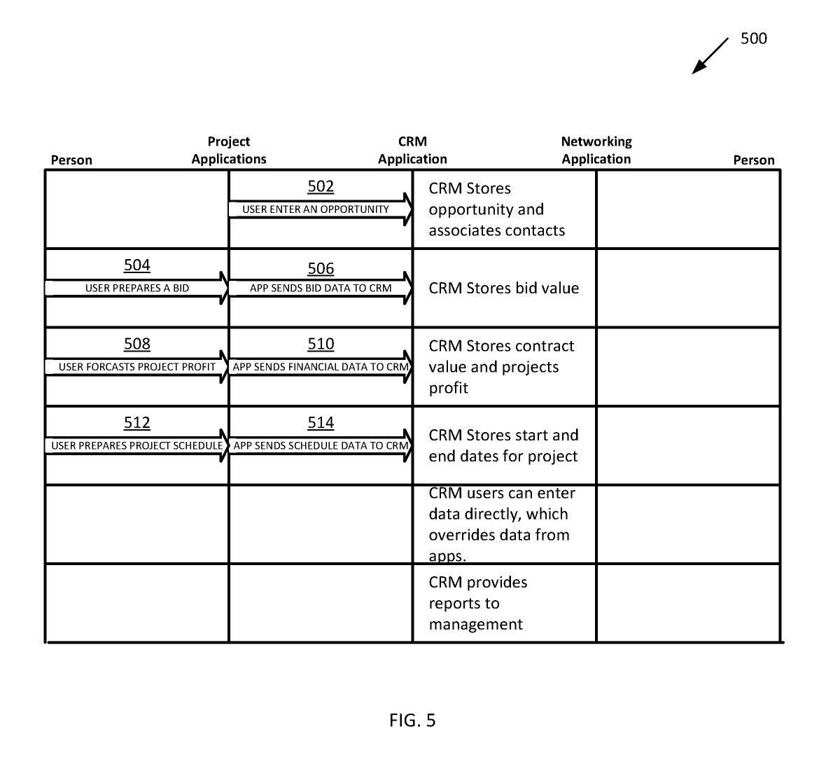

FIG. 5 is a communication flow diagram illustrating an example process 500 for data sharing in an integrated CRM and project management system. Process 500 begins at step 502, where a user entered opportunity (e.g., a potential project contract) is sent from a project application (e.g., data collection application 145) to the enhanced CRM application 140, where the enhanced CRM application 140 stores information regarding the opportunity and any information on any associated contacts in the CRM data store 115. In step 504, the user prepares a bid on the contract opportunity using bidding and estimating application 155. In step 506, the bidding and estimating application sends the bid data to the enhanced CRM application 140, where the bid value is stored and project profit is calculated. In step 508, the user forecasts project profit using, for example, project management application 150. In step 510, the project profit forecast is sent by the project management application 150 to the enhanced CRM system 140, where the contract value and projected project profit is stored. In step 512m the user prepares a project schedule using, for example, project scheduling application 165. In step 514, project scheduling application 165 sends the project schedule data to the enhanced CRM application 140 where the schedule data is stored. Subsequently, any authorized CRM user with adequate access privileges can enter project data directly, which may override data provided automatically by the project applications. Additionally, the enhanced CRM application 140 may be configured to provide periodic project status reports to designated management personnel based on predetermined reporting criteria.

Thus, in accordance with various examples described herein, a system for maintaining project information across project applications during all phases of a project has been disclosed. The disclosed systems and methods enable project-wide communication beyond simple peer-to-peer communication in conventional systems.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A system, comprising:
a processor; and
a non-transitory computer readable storage medium configured to store and execute instructions to:
receive, at a customer relationship management (CRM) platform, a request from an authorizing user to add a user to a project;
send an invitation to the user to join the project, via a networking platform;
receive an acceptance from the user and storing user contact information from the networking platform; and
authorize access by the user to one or more project applications, wherein the user is provisioned in a project management system.

2. The system of claim 1, wherein to authorize access to the user, the non-transitory computer readable storage medium further includes instructions to:
associate the user with a project;
update a project list and a project user list;
send the project list and the project user list to the one or more project applications; and
receive confirmation of the association from the one or more project applications.

3. The system of claim 1, wherein the non-transitory computer readable storage medium further includes instructions to:
receive, at a customer relationship management (CRM) platform, a contract opportunity;
associate the contract opportunity with project contacts;
receive, via one of the one or more project applications, contract bid data from a project contact, contract value and profit data, and contract schedule data, wherein data in the project management system is shared;
allocate resources to the project and establishing beginning and ending dates for the project; and
generate a distribution list for project management reports.

4. A method, comprising:
receiving, at a customer relationship management (CRM) platform, a request from an authorizing user to add a user to a project;
sending an invitation to the user to join the project, via a networking platform;
receiving an acceptance from the user and storing user contact information from the networking platform; and
authorizing access by the user to one or more project applications, wherein the user is provisioned in a project management system.

5. The method of claim 4, wherein authorizing access to the user comprises:
associating the user with a project;
updating a project list and a project user list;
sending the project list and the project user list to the one or more project applications; and
receiving confirmation of the association from the one or more project applications.

6. The method of claim 4, further comprising:
receiving, at a customer relationship management (CRM) platform, a contract opportunity;
associating the contract opportunity with project contacts;
receiving, via one of the one or more project applications, contract bid data from a project contact, contract value and profit data, and contract schedule data, wherein data in the project management system is shared;
allocating resources to the project and establishing beginning and ending dates for the project; and
generating a distribution list for project management reports.

7. An article of manufacture, comprising a non-transitory computer-readable storage medium encoded with instructions that, when executed by a processor, cause the processor to perform operations, comprising:
receiving, at a customer relationship management (CRM) platform, a request from an authorizing user to add a user to a project;
sending an invitation to the user to join the project, via a networking platform;
receiving an acceptance from the user and storing user contact information from the networking platform; and
authorizing access by the user to one or more project applications, wherein the user is provisioned in a project management system.

8. The article of manufacture of claim 7, wherein authorizing access to the user comprises:
associating the user with a project;
updating a project list and a project user list;
sending the project list and the project user list to the one or more project applications; and
receiving confirmation of the association from the one or more project applications.

9. The article of manufacture of claim 7, wherein the non-transitory computer-readable storage medium further includes instructions for:
receiving, at a customer relationship management (CRM) platform, a contract opportunity;
associating the contract opportunity with project contacts;
receiving, via one of the one or more project applications, contract bid data from a project contact, contract value and profit data, and contract schedule data, wherein data in the project management system is shared;
allocating resources to the project and establishing beginning and ending dates for the project; and
generating a distribution list for project management reports.
